(19) United States
(12) Patent Application Publication
(10) Pub. No.: US 2015/0202724 A1
(43) Pub. Date: Jul. 23, 2015

(54) Double-Sided Micro Fin Plate for Plate Heat Exchanger

(71) Applicant: Wolverine Tube, Inc., Decatur, AL (US)

(72) Inventors: Peter Beucher, Owens Cross Roads, AL (US); Donald Lynn Smith, Danville, AL (US); Sy-Jenq Loong, Madison, AL (US)

(73) Assignee: Wolverine Tube, Inc., Decatur, AL (US)

(21) Appl. No.: 14/603,303

(22) Filed: Jan. 22, 2015

Related U.S. Application Data
(60) Provisional application No. 61/930,241, filed on Jan. 22, 2014.

(51) Int. Cl. B23P 15/26

(52) U.S. Cl. CPC B23P 15/26; B23P 2700/10

(57) ABSTRACT

A method for producing a plate heat exchanger uses micro deformation technology to form fins on both sides of a sheet of metal. In the method, a substantially flat, substantially thin sheet of metal is restrained in a tooling fixture. The sheet has a first flat side and a second flat side. Fins are formed in the first and second flat sides of the sheet by slicing the sheet with a tool to create monolithic fins extending from the sheet. A base plate is formed by cutting the finned portions from the sheet. The base plate is used to form a plate heat exchanger.

### REFERENCE TO RELATED APPLICATIONS

This application claims priority to U.S. Provisional Patent Application Ser. No. 61/930,241, entitled “Double Sided Micro Fin Plate for Heat Exchanger” and filed on Jan. 22, 2014, which is fully incorporated herein by reference.

### BACKGROUND

Plate heat exchangers (PHE) have now become widely used in heating, refrigeration and industrial applications. A PHE is a type of heat exchanger that uses stacked metal plates to transfer heat between two fluids. The PHE allows fluid at different temperature to come into close proximity, separated only by channel plates that enable heat from one fluid to be transferred to the other with very high efficiency.

The PHE provides a number of advantages over a traditional shell-and-tube heat exchanger. For example, PHEs are typically compact and light weight, allowing them to be installed in very restrictive and tight environments. In PHEs, the separating wall between hot and cold fluid is typically a very thin sheet metal plate, resulting in higher conduction heat transfer. Also, the flow pattern in a PHE is very turbulent allowing for an extremely high heat transfer coefficient. The fabrication of PHEs is typically simpler than shell and tube heat exchangers, which results in relatively low initial costs, and the assembly and dismantling of PHEs is easier than traditional heat exchangers. Importantly, the capacity of a PHE can be increased or decreased easily by increasing or decreasing the number of plates in a stack of PHEs. Because of these many advantages, the PHE has been gradually replacing the shell-and-tube heat exchanger in both industrial and commercial applications.

A compact PHE that is known in the art consists of a series of stacked thin, corrugated plates. These plates are gasketed, welded or brazed together depending on the application of the PHE. The plates are compressed together in a rigid frame to form an arrangement of parallel flow channels with alternating hot and cold media. Larger commercial versions typically use gaskets between the plates while smaller versions tend to be brazed.

These corrugated plates have a wide variety of corrugation profiles, heights and angles, which are generally laid on top of one another to form parallel flow passages between the plates. At the top and bottom of each plate, the pairs of ports and joining line are connected in such a fashion so that the two process fluids pass through alternating plates, creating a nearly counter-current flow design. Corrugated plates are typically formed from stamped metal and do not have enhanced surfaces. Stainless steel is a commonly used metal for the plates.

### SUMMARY

A heat exchanger of the present disclosure advances PHE technology by enhancing the surfaces of the plates with micro deformation technology (MDT). Utilizing MDT enhanced surfaces instead of corrugation increases the surface area of the plates by 5-15 percent while decreasing the thickness of the PILE stack by 20-50 percent or more. The surfaces of both sides of the plates can be enhanced with MDT.

With the MDT enhanced surfaces, one type of plate surface can be used for both fluids or a different type of plate surface can be used for each fluid. This flexibility allows the pressure drop and thermal performance of each fluid to be independently controlled in optimizing the design of the PHE.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is an exploded perspective view of a prior art plate heat exchanger.

FIG. 2 is an unexploded perspective view of the prior art heat exchanger of FIG. 1.

FIG. 3 is a perspective view of a single plate according to an embodiment of the present disclosure.

FIG. 3a is an enlarged view of the plate of FIG. 3, showing an MDT enhanced top surface and bottom surface of the plate of FIG. 3.

FIG. 4 is a perspective view of a tool forming fins in a plate.

FIG. 5 is a cross sectional view of a plate with a tool forming fins in the plate.

FIG. 6 is a top plan view showing how an exemplary plate is formed from a sheet of material.

FIG. 7 is a side plan view of the sheet of FIG. 6 secured to a tooling fixture during the process of micro-deforming fins into the first flat side of the sheet.

FIG. 8 is a top plan view of the sheet of FIG. 6, following the micro-deforming of fins into the first flat side of the sheet.

FIG. 9 is a side plan view of the sheet of FIG. 8.

FIG. 10 depicts the sheet of FIG. 9 affixed to a fixture for the process of micro-deforming fins (not shown) into the second flat side of the sheet.

FIG. 11 is representational side view of the sheet of FIG. 10.

FIG. 12 is a side plan view of the sheet of FIG. 11 following micro-deforming of fins into the second flat side of the sheet.

FIG. 13 is a flowchart depicting an exemplary method for forming a plate heat exchanger using micro deformation technology in accordance with an exemplary embodiment of the disclosure.

FIG. 14 is a perspective view of a tool forming a pin from a fin.

FIG. 15 is a flowchart depicting an alternative exemplary method for forming a double-sided base plate for a heat exchanger micro deformation technology in accordance with an exemplary embodiment of the disclosure.

FIG. 16 depicts a sheet from which a double-sided micro deformed plate will be formed.

FIG. 17 depicts the sheet of FIG. 16 after an island has been machined in the sheet.

FIG. 18 depicts fins formed in a first side of the sheet of FIG. 17

FIG. 19 depicts the fins of FIG. 18 following a machining to square the edges of the fin area.

FIG. 20 depicts the sheet of FIG. 19 following the machining of an island into the second side.

FIG. 21 depicts the sheet of FIG. 20 after fins have been sliced into the island of the second side.

FIG. 22 depicts the sheet of FIG. 2 following a machining to square the edges of the fin area.

### DETAILED DESCRIPTION

FIG. 1 is an exploded perspective view of a prior art plate heat exchanger 20. A plurality of plates 10 are stacked together with their longitudinal edges 11 sealed together, creating flow paths 10a-10f between the plates 10. The sealing of the edges 11 may be accomplished with gaskets, welding, brazing, or other sealing techniques. A first fluid medium 12 (represented by solid-lined arrows, and generally a cold fluid) is flowed into a first input port 13, which directs the first fluid medium 12 through alternate flow paths 10b, 10d and 10f and out through first outlet port 15. A second fluid medium 14 (represented by dash-lined arrows, and generally a hot fluid) is flowed into a second input port 16, which directs the second fluid medium 14 through alternate flow paths 10a, 10c, and 10e and out through second outlet port 17.

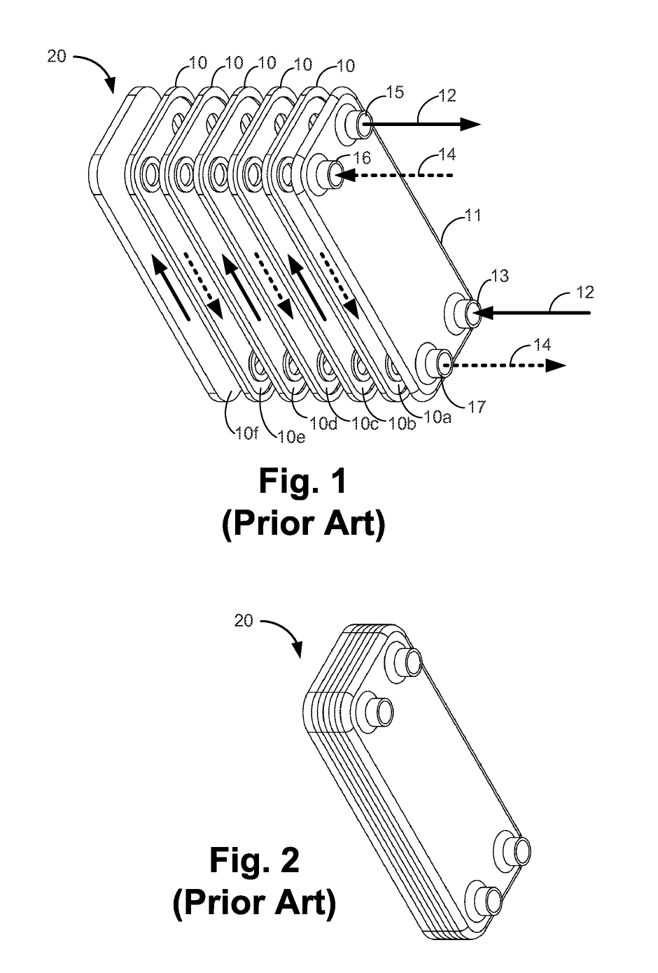

FIG. 2 is a perspective view of the heat exchanger 20 of FIG. 1, unexploded.

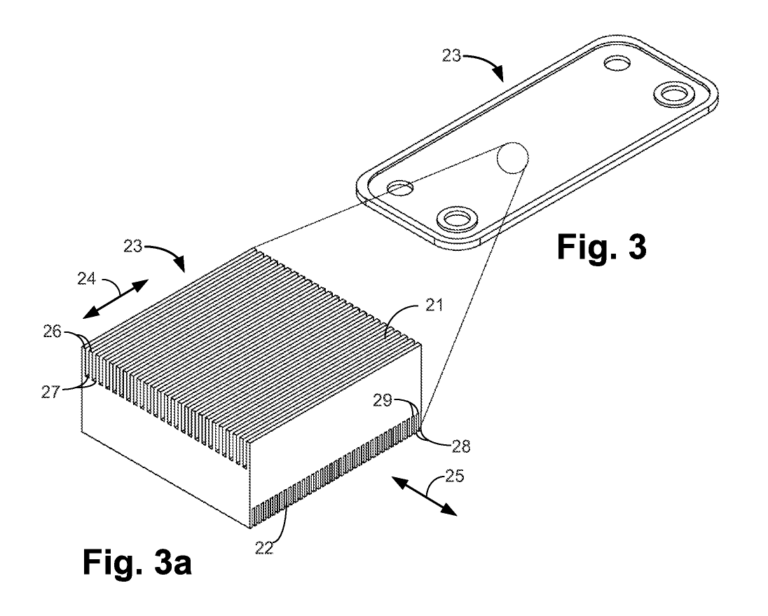

FIG. 3 is a perspective view of a single plate 23 according to an embodiment of the present disclosure. FIG. 3a is an enlarged view of the plate 23 of FIG. 3, showing the MDT enhanced top surface 21 and bottom surface 22 of the plate 23. The top surface 21 comprises a plurality of MDT-formed fins 26 extending upwardly from the plate 23. The fins 26 are substantially parallel to one another and aligned in a direction indicated by directional arrow 24.

The fins 26 form channels 27 therebetween, as further discussed herein.

The bottom surface 22 of the plate 23 comprises a plurality of MDT-formed fins 28 extending downwardly from the plate 23. The fins 28 are substantially parallel to one another and aligned in a direction indicated by directional arrow 25. The fins 28 form channels 29 therebetween. The fins 28 are substantially perpendicular to the fins 26 in the illustrated embodiment. In other embodiments, the fins 28 and fins 26 may be disposed at other angles with respect to one another. Finally, the fins 28 and fins 26 may be parallel to one another.

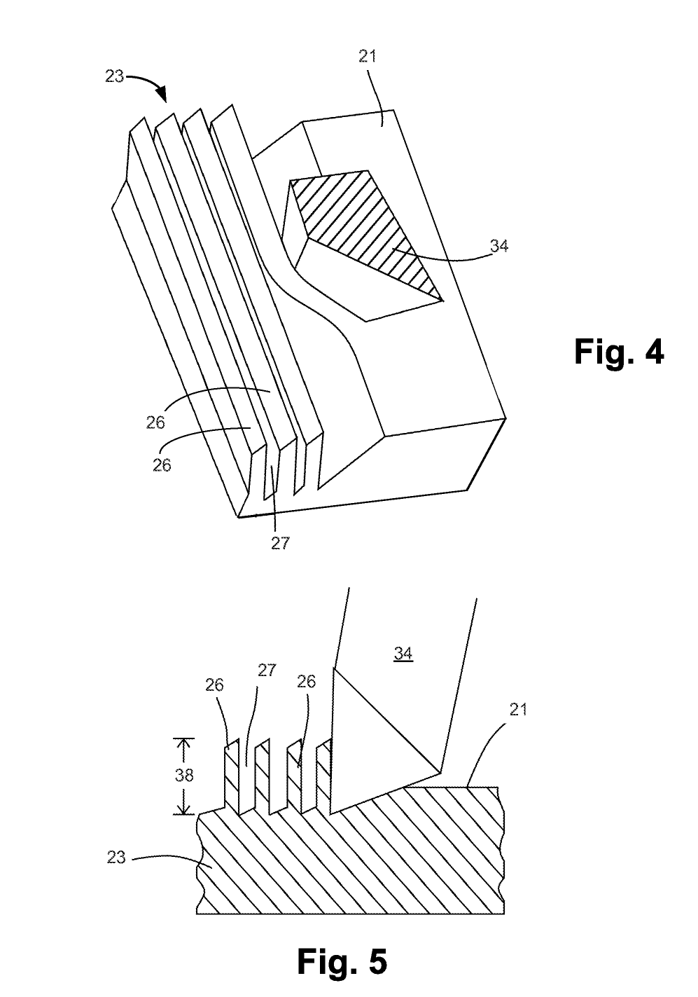

FIG. 4. illustrates fins 26 being formed in a plate 23. The same process discussed herein for forming the fins 26 is employed with the fins 28. The fins 26 are formed directly from the material of the plate 23 and are monolithic with the plate 23. In one embodiment, the plate 23 begins as a flat piece of metal. The MDT process is described in U.S. Pat. No. 5,775,187, issued Jul. 7, 1998, which is hereby incorporated by reference into this description. In this process, the plate 23 is sliced with a tool 34 without removing material from the plate 23. The MDT process is different than a saw or router, which removes material as cuts are made, and is more similar to the cutting of meat with a knife.

As the tool 34 contacts the material of the plate 23, a fin 26 is cut into the top surface 21. The slicing of the fins 26 from the plate 23 results in the fins 26 being monolithic with the plate 23, which improves heat transfer as discussed above. The fins 26 are formed directly from the material of the plate 23, so there is no joint or break between the fin 26 and the plate 23.

FIG. 5 is a cross-sectional view of the fin-cutting process discussed with respect to FIG. 4 above. The cutting of the plate 23 forms a channel 27 between adjacent fins 26, and can be done without removing material from the plate 23. Preferably, there are no shavings produced in the formation of the fins 26. The tool 34 slices fins 26 into the plate 23, and the space produced as the tool 34 passes through the plate 23 forces material in the fins 26 upwards. This cutting and deformation of the plate 23 causes the fins 26 to rise to a fin height 38 which is higher than the original height of the top surface 21. The design of the tool 34, the depth of the cut, and the width of the fins 26 and channels 27 are factors which affect the fin height 38. The tool 34 is moved slightly in one direction for each successive cut, so each cut forms a fin 26 adjacent to the previously cut fin 26. This process is repeated until a bed of fins 26 has been produced.

The fins 26 are cut at a specified fin width, and the channels 27 are of a specified width, so there are a predetermined number of fins 26 per centimeter. Many dimensions of the fins 26 can be controlled by specifying the tool design and settings for the machining operation used.

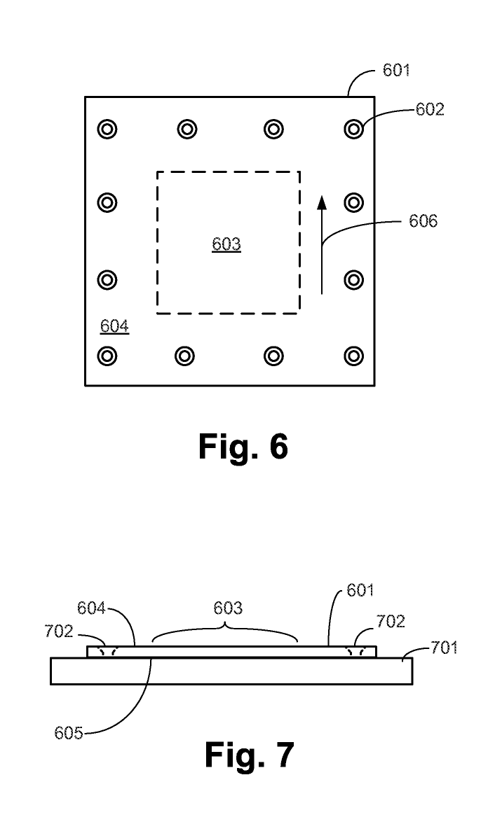

FIG. 6 is a top plan view showing how an exemplary plate is formed from a sheet 601 of material. The sheet 601 illustrated is a rectangular, very thin sheet of metal. In one embodiment the sheet 601 is 6 millimeter thick copper, for example. The size of the sheet 601 needed is determined by the size of the desired fin area (designated in FIG. 6 with reference numeral 603) for the fins that will be micro-deformed into a first flat side 604 of the sheet 601. Counter-sunk openings 602 are spaced apart around the edges of the sheet 601, outside of the desired fin area 603, for the insertion of fasteners (not shown) that will be used to secure the sheet 601 to a fixture (not shown), as discussed below with reference to FIG. 7.

FIG. 7 is a side plan view of the sheet 601 of FIG. 6 secured to a tooling fixture 701 during the process of micro-deforming fins (not shown) into the first flat side 604 of the sheet 601. A second flat side 605 of the sheet 601 contacts the fixture 701 as shown. A plurality of fasteners 702 securely affixes the sheet 601 to the fixture 701. The desired fin area 603 is generally in the center of the sheet 601 as shown.

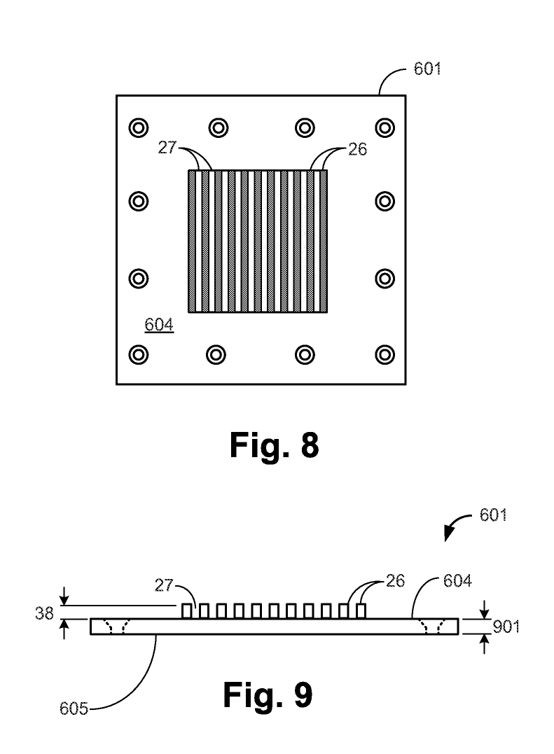

FIG. 8 is a top plan view of the sheet 601 of FIG. 6 following the micro-deformation of the first flat side 604 of the sheet 601. A plurality of fins 26 extend upwardly from the first flat side in substantially parallel rows, with channels 27 between the fins 26. Note that the fins 26 are illustrated in FIG. 8 in shading to differentiate the fins 26 from the channels 27.

FIG. 9 is a side plan view of the sheet 601 of FIG. 8. Note that the fins 26 protrude above the first flat side 604. Further, the fins 26 are monolithic with the first flat side 604. An exemplary fin height 38 is two (2) millimeters.

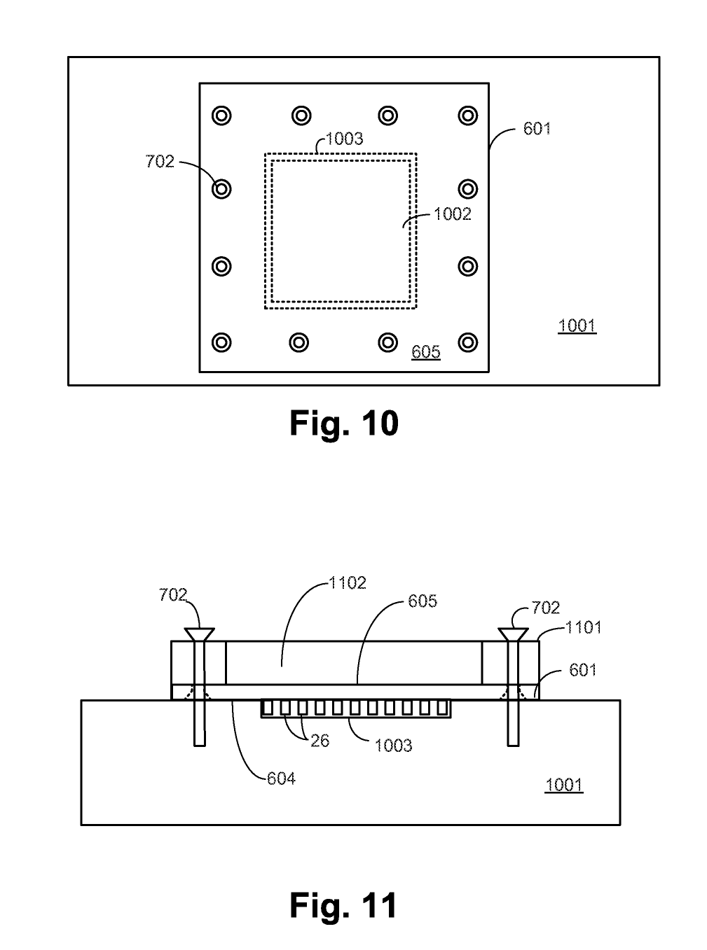

FIG. 10 depicts the sheet 601 of FIG. 9 affixed to a fixture 1001 for the process of micro-deforming fins (not shown) into the second flat side 605 of the sheet 601. During this step of the process, the first flat side 604 (FIG. 9) contacts the fixture 1001. To protect the fins 26 (FIG. 9) that were formed in the first flat side 604, the fins 26 are disposed in a pocket 1003 is recessed into the fixture 1001 so that the fins 26 do not contact the fixture 1001, as further illustrated in FIG. 11. Reference numeral 1002 illustrates the desired fin location of the fins to be formed on the second flat side 605.

FIG. 11 is representational side view of the sheet 601 of FIG. 10. The fixture 1001 comprises the pocket 1003 recessed within the fixture 1001 for receiving the fins 26. A retaining frame 1101 with a window 1102 is installed above the sheet 601. [Note that the retaining frame 1101 is not shown in FIG. 10, for the sake of clarity of FIG. 10.] The retaining frame 1101 comprises openings for receiving the fasteners 702 that secure the retaining frame 1101 to the sheet 601 and the sheet 601 to the fixture 1001. The window 1102 is an opening in the retaining frame 1101 that exposes most of the surface of the second flat side 605 so that fins (not shown) can be sliced in the second flat side using the process discussed herein.

FIG. 12 is a side view of the sheet 601 following micro-deformation of fins 26b into the second flat side 605. [Note that the fins in the first flat side 604 are designated by reference numeral 26a in FIG. 12.] The fins 26b extend from the second flat side 605. Further, the fins 26b are monolithic with the second flat side 605. An exemplary fin height 38b is two (2) millimeters. Following micro-deformation of the fins 26a and 26b into the sheet 601, the resultant sheet (including the fins) is thicker than the original thickness 901. In other words, the final thickness of the sheet 601 is the original thickness 901 plus the fin height 38 (FIG. 9) and the fin height 38b (FIG. 12).

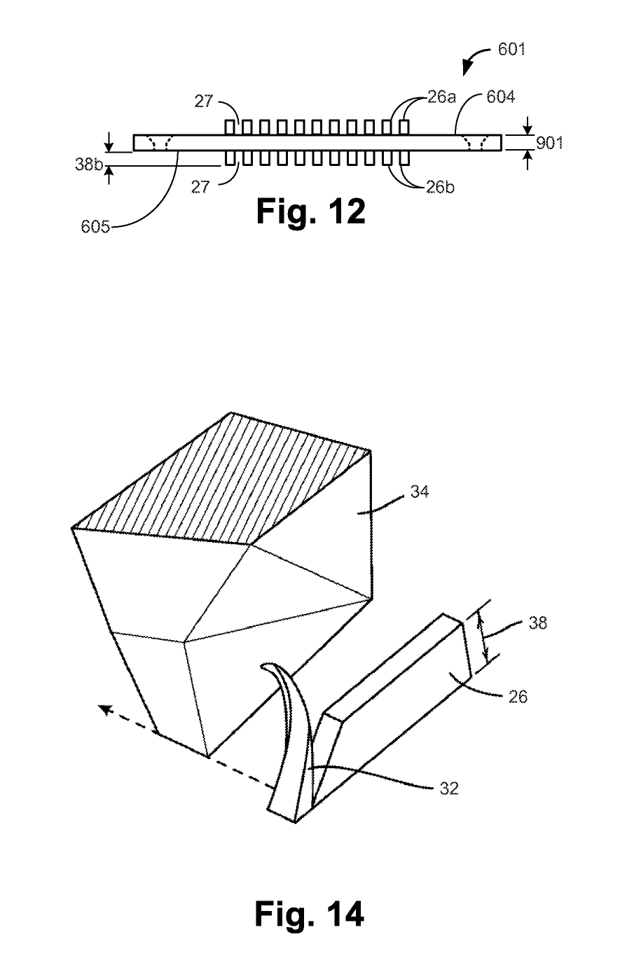

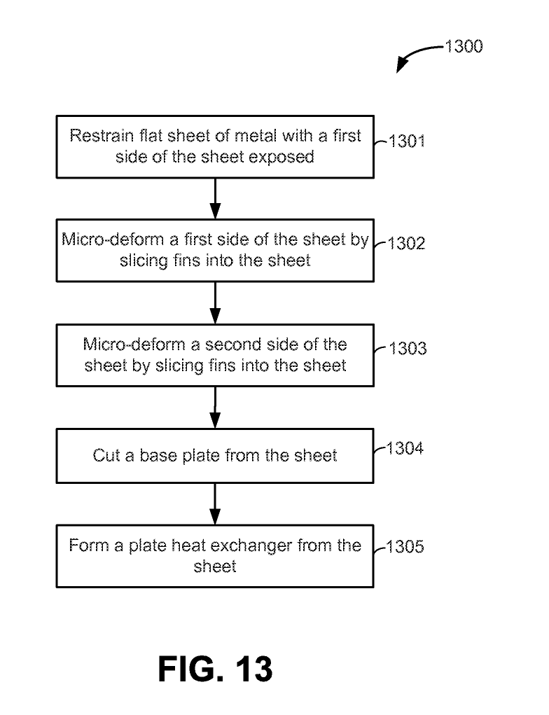

FIG. 13 is a flowchart depicting an exemplary method 1300 for forming a plate heat exchanger using micro deformation technology in accordance with an exemplary embodiment of the disclosure. In step 1301 of the method 1300, the sheet 601 (FIG. 6) is restrained in a fixture 701 (FIG. 7) with the first flat side 604 (FIG. 6) exposed.

In step 1302, a tool 34 (FIG. 4) micro-deforms the first flat side 604 by slicing fins 26 (FIG. 4) into the sheet 601. The sheet 601 may then be removed from the fixture 701 and installed in the fixture 1001 (FIG. 11) with the fins 26 (FIG. 11) recessed into a pocket 1003 (FIG. 11) of the fixture 1001 and the second flat side 605 exposed. Then in step 1303, the tool 34 (FIG. 4) micro-deforms the second flat side 605 by slicing fins into the second flat side 605.

In step 1304, a base plate (not shown) is cut from the sheet 601 by cutting out the finned portion from the sheet 601. In step 1305, a plate heat exchanger (not shown) is formed by stacking the desired number of base plates together.

In an alternative embodiment of the plate 23, the fins 26 (FIG. 4) are “cross-sliced” to form individual pins extending from and monolithic with the plate 23. FIG. 14 is a perspective view of a tool 34 forming a pin 32 from a fin 26. The pin 32 is formed by cross cutting the fins 26; the pin 32 is therefore monolithic with the plate 23 (FIG. 5). Pins 32 are made by slicing across the fins 26 with a second series of cuts. The second set of slices can also use the MDT method. As the slices are made, no material is removed from the plate 23, so the moved material is instead directed into the remaining pin 32. This causes the pin 32 to rise to a height higher than the fin height 38. The second set of slices can be made at a wide variety of angles to the fins 26, including ninety degrees or an angle other than ninety degrees. Additionally, the incline angle of the pin 32 and/or the fin 26 can be manipulated by the angle of the tool 34 as the slices are made. A modification of the incline angle of the fin 26 can change the incline angle of the pin 32. Formation of pins 32 is discussed in further detail in US Patent Publication 2011/0079376, titled “Cold Plate with Pins,” which is incorporated herein by reference.

The MDT cutting process can be performed on a CNC milling machine, a lathe, a shaper, or other machining tools. A specially modified vacuum work holding fixture is needed to securely hold down the fin plate while cutting the fins 26. The cutting depth should not be so deep that the integrity of the plate 23 is compromised, and the cutting depth should be deep enough to produce an enhancement of sufficient area and height to achieve the desired heat transfer rate.

The plate 23 is typically formed from copper and aluminum. However, other metals may be used in the alternative, and a low cost finned plastic plate may be a good alternative for residential heat pump applications.

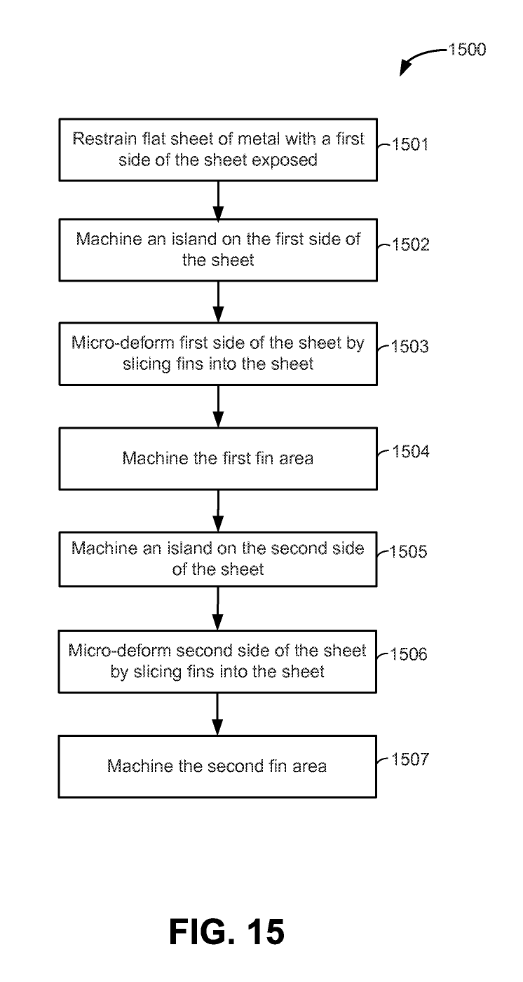

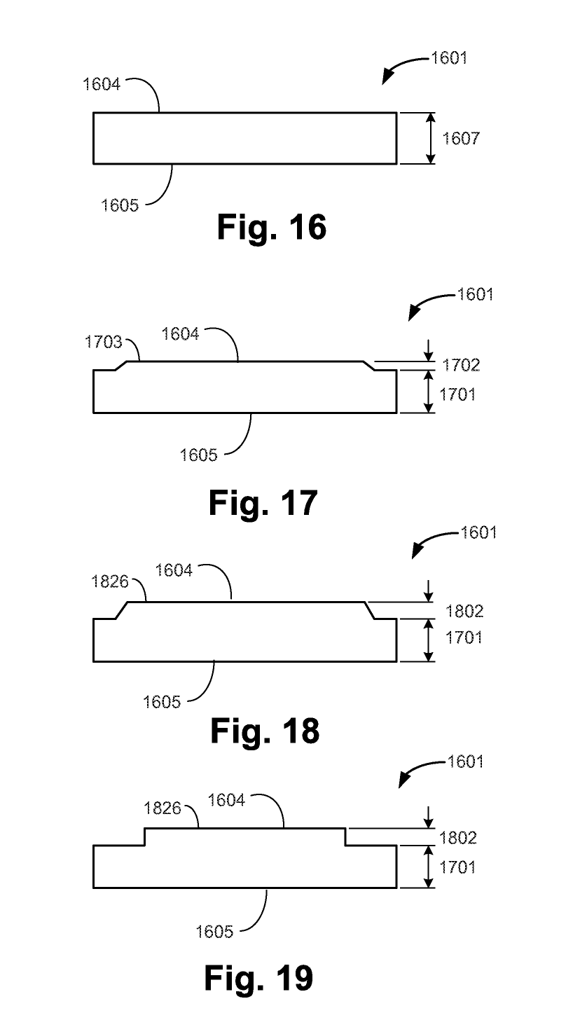

FIG. 15 is a flowchart depicting an alternative exemplary method 1500 for forming a double-sided base plate for a heat exchanger using micro deformation technology in accordance with an exemplary embodiment of the disclosure. FIGS. 16-22 illustrate the steps in the method. Note that FIGS. 16-22 are not to scale, and that the sheet is much thinner than it appears.

In step 1501, the sheet 1601 (FIG. 16) is restrained in a fixture (not shown) with a first side 1604 of the sheet 1601 facing upwards. The sheet 1601 (FIG. 16) has an original thickness 1607 that is 6 millimeters in an exemplary embodiment.

In step 1502, an “island” 1703 (FIG. 17) is machined into the first side 1604. FIG. 17 illustrates the sheet 1601 after step 1502. The island is a raised portion of the sheet 1601. The island has an original thickness of 1702 and the remaining sheet has a thickness of 1701. In one embodiment, 1702 is 1 millimeter and 1701 is five (5) millimeters.

In step 1503, the island is finned using the micro-deformation process discussed herein. FIG. 18 illustrates the fins 1826 resulting from step 1503. Note that the fins are shown raised from the sheet 1601 in profile view, such that only the end fin is visible. The slicing of the fins from the island 1703 (FIG. 17) causes the fins to extend from the island, resulting in a fin thickness 1802 that is larger than the island thickness 1702. In one embodiment, where the island thickness was 1 millimeter, the fin thickness is 2 millimeters.

In step 1504, the fins 1826 are machined to “square” the edges of the fin area. The thickness of the fins 1826 is not changed from this step. FIG. 19 depicts the sheet 1601 following step 1504.

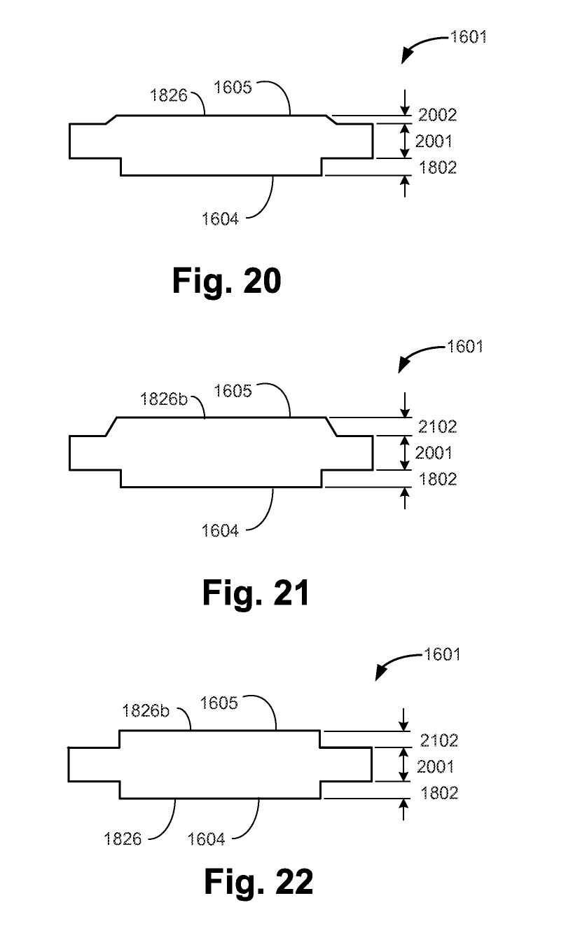

In step 1505, the sheet 1601 is flipped such that the second side 1605 faces upwards. An island 2003 is machined into the second side 1605 in the same manner as discussed above. FIG. 20 depicts the sheet 1601 following step 1505. The thickness of the island is 2002, and is 1 millimeter in one embodiment. The thickness of the middle portion of the plate 2001 decreases by the thickness of the island. In one embodiment, the thickness of the middle portion of the plate 2001 is 3 millimeters following step 1506.

In step 1506, the island 2003 (FIG. 20) is finned using the micro-deformation process discussed herein. FIG. 21 illustrates the fins 1826b resulting from step 1506. The slicing of the fins from the island 2003 causes the fins 1826b to extend from the island, resulting in a fin thickness 2102 that is larger than the island thickness 2002. In one embodiment, where the island thickness 2002 was 1 millimeter in step 1505, after step 1506 the fin thickness is 2 millimeters, the middle portion 2001 is still 3 millimeters, and the fin thickness 1802 is still 2 millimeters.

In step 1507, the fins 1826b are machined to “square” the edges of the fin area. The thickness of the fins 1826b is not changed from this step. FIG. 22 depicts the sheet 1601 following step 1507.

What is claimed is:

1. A method of producing a plate heat exchanger using micro deformation technology, the method comprising:
restraining a substantially flat, substantially thin sheet of metal, the sheet comprising an initial thickness, the sheet further comprising a first flat side and a second flat side, the second flat side opposed to the first flat side;
micro-deforming the first flat side by slicing the first flat side with a tool to form a first plurality of fins monolithic with the sheet, the first plurality of fins comprising substantially parallel rows of protrusions extending from the first flat side;
micro-deforming the second flat side by slicing the second flat side with a tool to form a second plurality of fins monolithic with the sheet, the second plurality of fins comprising substantially parallel rows of protrusions extending from the second flat side;
cutting a base plate from the sheet, the base plate comprising the first plurality of fins and the second plurality of fins;
forming a plate heat exchanger from the base plate, such that when the heat exchanger is in operation, a hot fluid contacts the first plurality of fins and a cold fluid contacts the second plurality of fins.

2. The method of claim 1, wherein the first plurality of fins are substantially perpendicular to the second plurality of fins.

3. The method of claim 1, wherein the initial thickness is less than six (6) millimeters.

4. The method of claim 3, wherein the first plurality of fins has a height of two (2) millimeters or less.

5. The method of claim 4, wherein the second plurality of fins has a height of two (2) millimeters or less.

6. The method of claim 1 where the steps of micro-deforming the first flat side and the second flat side comprises slicing the sheet without removing material from the sheet, such that the fins elevate from the sheet.

7. The method of claim 1 where a thickness of the sheet following the steps of micro-deforming the first flat side and the second flat side is larger than the initial thickness.

8. The method of claim 1, further comprising cross-slicing the first plurality of fins to form a plurality of pins monolithic with the sheet on the first flat side of the sheet.

9. The method of claim 8, further comprising cross-slicing the second plurality of fins to form a plurality of pins monolithic with the sheet on the second flat side of the sheet.

10. The method of claim 1, further comprising machining an island into the first and second flat sides before the first plurality of fins and second plurality of fins are formed.

11. The method of claim 1, wherein the hot fluid flows in a direction substantially parallel to the first plurality of fins and the cold fluid flows in a direction substantially parallel to the second plurality of fins.

12. A method of producing a double-sided micro-deformed base plate for use in a heat exchanger, the method comprising:
restraining a substantially flat, substantially thin sheet of metal, the sheet comprising a thickness, the sheet further comprising a first flat side and a second flat side, the second flat side opposed to the first flat side;
micro-deforming the first flat side by slicing the first flat side with a tool to form a first plurality of fins monolithic with the sheet, the first plurality of fins comprising substantially parallel rows of protrusions extending from the first flat side;
micro-deforming the second flat side by slicing the second flat side with a tool to form a second plurality of fins monolithic with the sheet, the second plurality of fins comprising substantially parallel rows of protrusions extending from the second flat side;
cutting a base plate from the sheet, the base plate comprising the first plurality of fins and the second plurality of fins.

13. The method of claim 12, further comprising forming a plate heat exchanger from the base plate, such that when the heat exchanger is in operation, a hot fluid contacts the first plurality of fins and a cold fluid contacts the second plurality of fins.

14. The method of claim 12, wherein the first plurality of fins are substantially perpendicular to the second plurality of fins.

15. The method of claim 12, wherein the sheet has an initial thickness of less than six (6) millimeters.

16. The method of claim 15, wherein the first plurality of fins has a height of two (2) millimeters or less.

17. The method of claim 16, wherein the second plurality of fins has a height of two (2) millimeters or less.

18. The method of claim 12 where the steps of micro-deforming the first flat side and the second flat side comprises slicing the sheet without removing material from the sheet, such that the fins elevate from the sheet.

19. The method of claim 12 where a thickness of the sheet following the steps of micro-deforming the first flat side and the second flat side is thicker than the initial thickness of the sheet.

20. The method of claim 12, further comprising cross-slicing the first plurality of fins to form a plurality of pins monolithic with the sheet on the first flat side of the sheet.
